(19) United States
(12) Patent Application Publication
(10) Pub. No.: US 2025/0092770 A1
(43) Pub. Date: Mar. 20, 2025

(54) PUMP CONTROL FRAMEWORK

(71) Applicant: Schlumberger Technology Corporation, Sugar Land, TX (US)

(72) Inventor: Debashis Gupta, Houston, TX (US)

(21) Appl. No.: 18/724,390

(22) PCT Filed: Feb. 23, 2023
(86) PCT No.: PCT/US2023/063092

§ 371 Date: Jun. 26, 2024

Related U.S. Application Data
(60) Provisional application No. 63/313,951, filed on Feb. 25, 2022.

(51) Int. Cl. E21B 43/12; E21B 37/08; E21B 41/00; G01V 1/50

(52) U.S. Cl. CPC E21B 43/128; E21B 37/08; E21B 41/00; G01V 1/50

(57) ABSTRACT

A method can include receiving data for a downhole pump operation that utilizes equipment that includes a pump; analyzing the data utilizing a local edge framework that executes a trained machine learning model to identify an operational condition of the downhole pump operation associated with a risk of a reduction in operational lifetime of the pump; and issuing an instruction to the equipment that addresses the operational condition.

### CROSS-REFERENCE TO RELATED APPLICATION(S)

The subject disclosure claims priority from U.S. Provisional Appl. No. 63/313,951, filed on 25 Feb. 2022, herein incorporated by reference in its entirety.

### BACKGROUND

Various techniques can be utilized for artificial-lift, which can, for example, help to produce fluid from a reservoir, etc. In various instances, artificial-lift may aim to enhance the production of liquid from a reservoir; whereas, in other instances, production of gas may be enhanced. Various artificial-lift techniques can employ pumps that are driven by an electric motor, which may be at surface or downhole.

### SUMMARY

A method can include receiving data for a downhole pump operation that utilizes equipment that includes a pump; analyzing the data utilizing a local edge framework that executes a trained machine learning model to identify an operational condition of the downhole pump operation associated with a risk of a reduction in operational lifetime of the pump; and issuing an instruction to the equipment that addresses the operational condition. A system can include a processor; memory accessible to the processor; processor-executable instructions stored in the memory and executable by the processor to instruct the system to: receive data for a downhole pump operation that utilizes equipment that includes a pump; analyze the data utilizing a local edge framework that executes a trained machine learning model to identify an operational condition of the downhole pump operation associated with a risk of a reduction in operational lifetime of the pump; and issue an instruction to the equipment that addresses the operational condition. One or more computer-readable storage media can include processor-executable instructions to instruct a computing system to: receive data for a downhole pump operation that utilizes equipment that includes a pump; analyze the data utilizing a local edge framework that executes a trained machine learning model to identify an operational condition of the downhole pump operation associated with a risk of a reduction in operational lifetime of the pump; and issue an instruction to the equipment that addresses the operational condition. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a system;

FIG. 2 illustrates an example of a system;

FIG. 3 illustrates an example of a system;

FIG. 4 illustrates an example of a system;

FIG. 5 illustrates an example of a method;

FIG. 6 illustrates an example of a framework and example techniques;

FIG. 7 illustrates an example series of plots;

FIG. 8 illustrates an example series of plots;

FIG. 9 illustrates an example of a plot;

FIG. 10 illustrates example plots;

FIG. 11 illustrates an example series of plots;

FIG. 12 illustrates an example series of plots;

FIG. 13 illustrates an example of a method;

FIG. 14 illustrates an example of a method;

FIG. 15 illustrates an example of a plot;

FIG. 16 illustrates an example of a field and an example of a controller;

FIG. 17 illustrates an example of a method;

FIG. 18 illustrates examples of computer and network equipment; and

FIG. 19 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

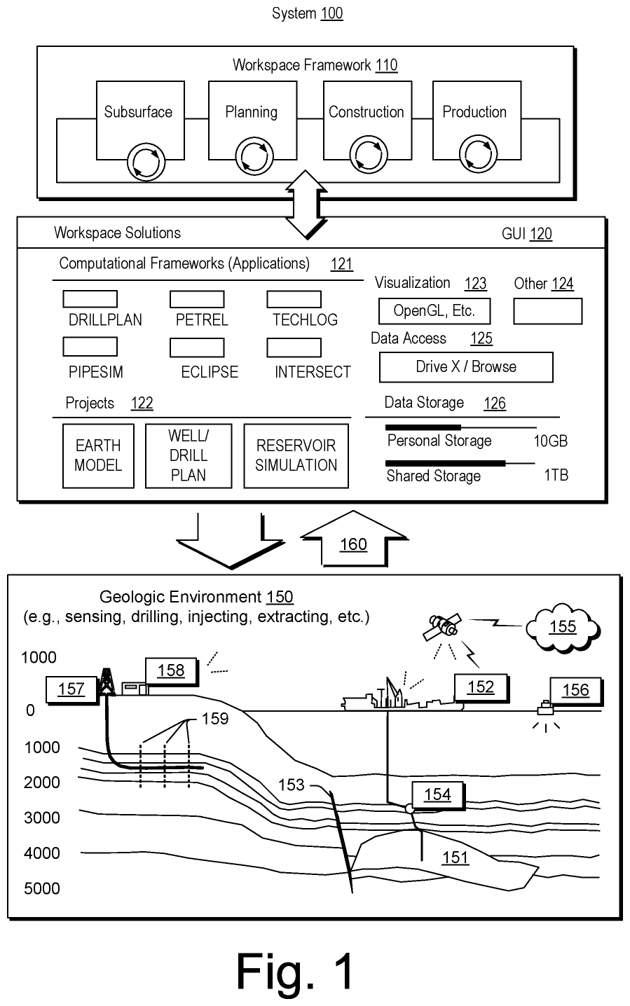

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows various features of a computational environment that can include various features of the DELFI environment, which may be referred to as the DELFI framework, which may be a framework of frameworks. As an example, the DELFI framework can include various other frameworks, which can include, for example, one or more types of models (e.g., simulation models, etc.). Some examples of frameworks can include the DRILLPLAN, PETREL, TECHLOG, PIPESIM, ECLIPSE, and INTERSECT frameworks (Schlumberger Limited, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework is part of the DELFI cognitive E&P environment (Schlumberger Limited, Houston, Texas) for utilization in geosciences and geoengineering, for example, to analyze subsurface data from exploration, to development, to drilling, to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (Schlumberger Limited, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G software packages.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1D, 2D, 3D or 4D seismic data). For example, consider acquisition equipment that acquires digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where later acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a simulator may utilize various types of constructs, which may be referred to as entities. Entities may include earth entities or geological objects such as wells, surfaces, reservoirs, etc. Entities can include virtual representations of actual physical entities that may be reconstructed for purposes of simulation. Entities may include entities based on data acquired via sensing, observation, etc. (e.g., consider entities based at least in part on seismic data and/or other information). As an example, an entity may be characterized by one or more properties (e.g., a geometrical pillar grid entity of an earth model may be characterized by a porosity property, etc.). Such properties may represent one or more measurements (e.g., acquired data), calculations, etc.

As an example, a simulator may utilize an object-based software framework, which may include entities based on pre-defined classes to facilitate modeling and simulation. As an example, an object class can encapsulate reusable code and associated data structures. Object classes can be used to instantiate object instances for use by a program, script, etc. For example, borehole classes may define objects for representing boreholes based on well data. A model of a basin, a reservoir, etc. may include one or more boreholes where a borehole may be, for example, for measurements, injection, production, etc. As an example, a borehole may be a wellbore of a well, which may be a completed well (e.g., for production of a resource from a reservoir, for injection of material, etc.). While several simulators are illustrated in the example of FIG. 1, one or more other simulators may be utilized, additionally or alternatively.

As mentioned, a framework may be implemented within or in a manner operatively coupled to the DELFI cognitive exploration and production (E&P) environment (SLB, Houston, Texas), which is a secure, cognitive, cloud-based collaborative environment that integrates data and workflows with digital technologies, such as artificial intelligence and machine learning. As an example, such an environment can provide for operations that involve one or more frameworks. The DELFI environment may be referred to as the DELFI framework, which may be a framework of frameworks. As an example, the DELFI framework can include various other frameworks, which can include, for example, one or more types of models (e.g., simulation models, etc.).

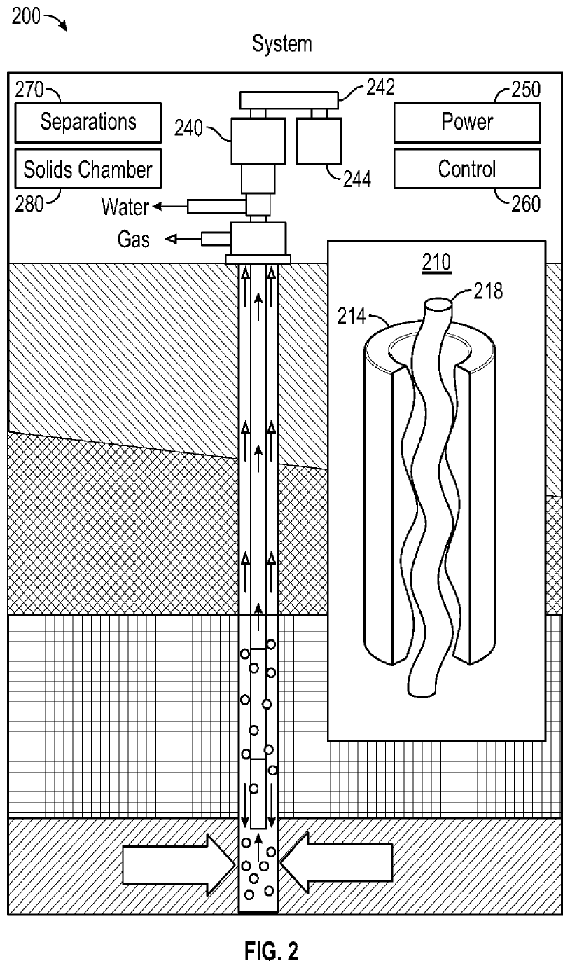

FIG. 2 shows an example of a system 200 in a geologic environment. As shown, the system 200 can include a progressive cavity pump (PCP) 210 that includes a stator 214 and a rotor 218 where the stator 214 includes a lining (e.g., elastomeric, etc.), that forms a cavity with respect to the rotor 218. In such an example, as the rotor 218 is rotated by drive head 240, the rotor 218 can provide for pumping of fluid, for example, upwardly in the cavity. In some instances, a so-called left helix PCP for downward flow of fluid may be utilized additionally or alternatively to a right helix PCP for upward flow of fluid.

In the example of FIG. 2, the drive head 240 is coupled to a transmission 242, which is coupled to an electric motor 244. In such an example, the transmission 242 may include one or more belts, one or more gears, etc. The electric motor 244 can be electrically coupled to a power source 250 and, for example, a controller 260. In such an example, the controller 260 may control supply of power from the power source 250 to the electric motor 244 to control rotation of the rotor 218 of the PCP 210.

In the example of FIG. 2, the system 200 can include surface equipment such as, for example, separations equipment 270, which may include one or more solids chambers 280. In such an example, solids produced from the well may be separated out using the separations equipment 270 and collected in the one or more solids chambers 280. In such an example, a solids chamber can include a sensor that can provide information as to level of solids collected in the solids chamber. As an example, once full, a solids chamber may be emptied, which may be a manual process that demands human intervention.

In the example of FIG. 2, the geologic environment is shown as being a coal seam gas geologic environment. Coal seam gas is natural gas found in coal deposits, generally about 300 to 600 meters underground. During the formation of coal, large quantities of gas are generated and stored within the coal on internal surfaces. Because coal has a relatively large internal surface area, it can store up to seven times as much gas as a conventional natural gas reservoir of equal rock volume.

Coal seam gas is held in place by water pressure. To extract coal seam gas, a well can be drilled through coal seams and water pressure reduced by extracting some of the water. As illustrated in the example of FIG. 2, the reduction in water pressure helps in releasing natural gas from the coal. As an example, gas and water can be separated such that the gas can be piped to a compression plant for transportation via a gas transmission pipeline. As an example, a gas turbine generator may be utilized as a power source where a portion of the gas is combusted to drive a gas turbine coupled to an electric generator to produce electrical power. For example, the power supply 250 may be a natural gas turbine generator. As an example, the controller 260 may be operatively coupled to a natural gas turbine generator to control the generation of electrical power to drive the electric motor 244 and hence the PCP 210. As an example, a single power source may be operatively coupled to one or more electric motors for driving one or more PCPs, etc.

In some cases hydraulic fracturing may be employed to facilitate extraction of coal seam gas. For example, consider injecting fluid under high pressure into a coal seam to widen existing fractures and create new ones. A proppant such as sand can be mixed with the injected fluid, carried into the fracture and serve to keep the fractures open once the fracture treatment is complete and the pressure is released. Such a process can enhances removal of water and extraction of coal seam gas.

As an example, a KUDU PCP (Schlumberger Limited, Houston, Texas) may be utilized in an operation such as the operation illustrated in FIG. 2. As an example, a PCP can be selected of a particular size, geometry, volume rate, etc.

As an example, a production process may optionally utilize one or more fluid pumps such as, for example, a PCP, an electric submersible pump (e.g., consider a centrifugal pump, a rod pump, etc.). As an example, a production process may implement one or more so-called “artificial lift” (or artificial-lift) technologies. An artificial lift technology may operate by adding energy to fluid, for example, to initiate, enhance, etc. production of fluid.

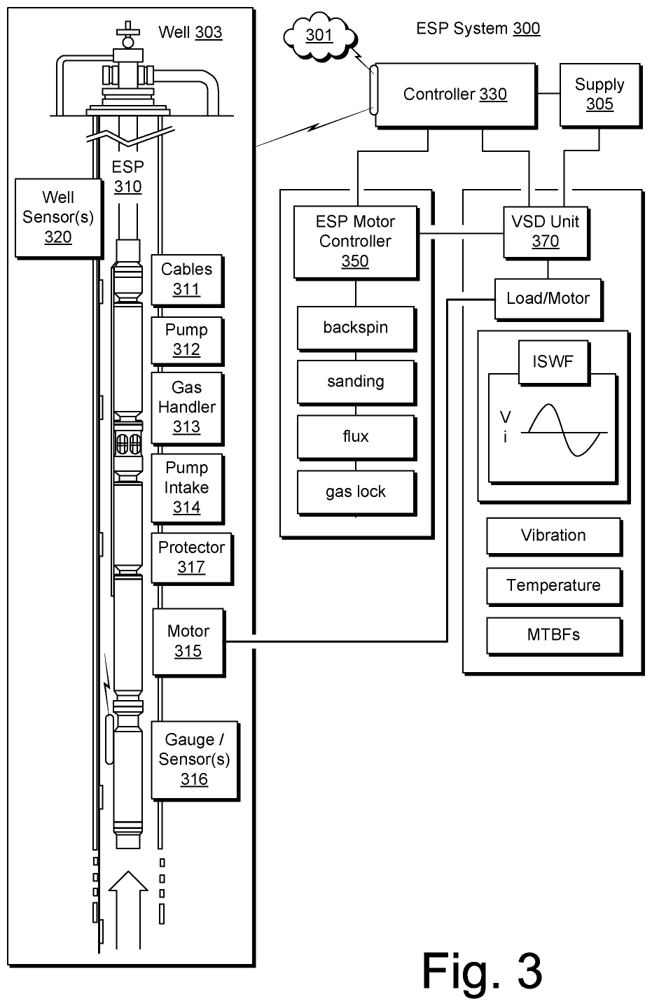

FIG. 3 shows an example of an ESP system 300 that includes an ESP 310 as an example of equipment that may be placed in a geologic environment. As an example, an ESP may be expected to function in an environment over an extended period of time (e.g., optionally of the order of years). As an example, one or more commercially available ESPs (such as the REDA ESPs, Schlumberger Limited, Houston, Texas) may find use in various operations.

In the example of FIG. 3, the ESP system 300 includes a network 301, a well 303 disposed in a geologic environment (e.g., with surface equipment, etc.), a power supply 305, the ESP 310, a controller 330, a motor controller 350 and a VSD unit 370. The power supply 305 may receive power from a power grid, an onsite generator (e.g., natural gas driven turbine), or other source. The power supply 205 may supply a voltage, for example, of about 4.16 kV.

As shown, the well 303 includes a wellhead that can include a choke (e.g., a choke valve). For example, the well 303 can include a choke valve to control various operations such as to reduce pressure of a fluid from high pressure in a closed wellbore to atmospheric pressure. Adjustable choke valves can include valves constructed to resist wear due to high-velocity, solids-laden fluid flowing by restricting or sealing elements. A wellhead may include one or more sensors such as a temperature sensor, a pressure sensor, a solids sensor, etc.

As to the ESP 310, it is shown as including cables 311 (e.g., or a cable), a pump 312, gas handling features 313, a pump intake 314, a motor 315, one or more gauge/sensor units 316 (e.g., temperature, pressure, strain, current leakage, vibration, etc.) and optionally a protector 317. As to an example of a gauge/sensor unit, consider the PHOENIX gauge (Schlumberger Limited, Houston, Texas).

As an example, an ESP motor can include a three-phase squirrel cage with two-pole induction. As an example, an ESP motor may include steel stator laminations that can help focus magnetic forces on rotors, for example, to help reduce energy loss. As an example, stator windings can include copper and insulation.

In the example of FIG. 3, the well 303 may include one or more well sensors 320. In the example of FIG. 3, the controller 330 can include one or more interfaces, for example, for receipt, transmission or receipt and transmission of information with the motor controller 350, a VSD unit 370, the power supply 305 (e.g., a gas fueled turbine generator, a power company, etc.), the network 301, equipment in the well 303, equipment in another well, etc.

As shown in FIG. 3, the controller 330 may include or provide access to one or more frameworks. Further, the controller 330 may include features of an ESP motor controller and optionally supplant the ESP motor controller 350. In the example of FIG. 3, the motor controller 350 may be a commercially available motor controller such as the UNICONN motor controller (Schlumberger Limited, Houston, Texas), which may be connected to a SCADA system. As an example, the motor controller 350 may perform some control and data acquisition tasks for ESPs, surface pumps or other monitored wells. As an example, the UNICONN motor controller can interface with the PHOENIX monitoring system, for example, to access pressure, temperature and vibration data and various protection parameters as well as to provide direct current power to downhole sensors (e.g., sensors of a gauge, etc.). The UNICONN motor controller can interface with fixed speed drive (FSD) controllers or a VSD unit, for example, such as the VSD unit 370.

For VSD units, the UNICONN motor controller can monitor VSD output current, ESP running current, VSD output voltage, supply voltage, VSD input and VSD output power, VSD output frequency, drive loading, motor load, three-phase ESP running current, three-phase VSD input or output voltage, ESP spinning frequency, and leg-ground.

In the example of FIG. 3, the ESP motor controller 350 includes various modules to handle, for example, backspin of an ESP, sanding of an ESP, flux of an ESP and gas lock of an ESP. The motor controller 350 may include any of a variety of features, additionally, alternatively, etc.

As to the motor 315, consider, for example, a REDA MAXIMUS PRO MOTOR electric motor (Schlumberger Limited, Houston, Texas), which may be a 387/456 series with a housing outer diameter of about 12 cm or a 540/562 series with a housing outer diameter of about 14 cm. As an example, consider a carbon steel housing, a high-nickel alloy housing, etc. As an example, consider an operating frequency of about 30 to about 90 Hz. As an example, consider a maximum windings operating temperature of about 200 degrees C. As an example, consider head and base radial bearings that are self-lubricating and polymer lined. As an example, consider a pot head that includes a cable connector for electrically connecting a power cable to a motor.

In the example of FIG. 3, a shaft segment of the pump 312 may be coupled via a connector to a shaft segment of the protector 317 and the shaft segment of the protector 317 may be coupled via a connector to a shaft segment of the motor 315. As an example, an ESP may be oriented in a desired direction, which may be vertical, horizontal or other angle (e.g., as may be defined with respect to gravity, etc.). Orientation of an ESP with respect to gravity may be considered as a factor, for example, to determine ESP features, operation, etc.

As shown in FIG. 3, the motor 315 is an electric motor that includes a cable connector, for example, to operatively couple the electric motor to a multiphase power cable, for example, optionally via one or more motor lead extensions. Power supplied to the motor 315 via the cable connector may be further supplied to the gauge/sensor unit 316, for example, via a wye point of the motor 315 (e.g., a wye point of a multiphase motor). Such an approach may also provide for transmission of information from the unit 316 to surface. As an example, the unit 316 can include transmission circuitry that can transmit information via a wye point of the motor 315 and via one or more of the cables 311 where such information may be received at a surface unit, etc. (e.g., consider a choke, etc. that can extract information from one or more multiphase power conductors, etc.).

The systems 200 and 300 of FIGS. 2 and 3 are examples of pumping systems that may be deployed in the field at sites that may be relatively remote. For example, consider an offshore site accessible by ship or helicopter, a land site that is remote from a population such that transportation may be problematic, etc.

As an example, a framework can provide for monitoring, control and optimization of one or more types of pumps (e.g., PCP, ESP, etc.), for example, with objectives of increasing run life and lowering operating cost.

In various operations, a workflow can include setting up operational thresholds based on pump characteristics as may be primarily based on the physics of measurement. For example, consider a SCADA based monitoring system that is used to acquire pump data where one or more thresholds are set on a programmable logic controller (PLC) to control a pump. In such an approach, certain pump optimization algorithms may be run on a server where these algorithms may be used to further optimize the pump run life. Such a set-up relies on a robust communication network between the pump and the server and also the computational power of the server to handle such algorithms. However, when a number of pumps are to be monitored, an end user is often challenged to prioritize the pumps to be addressed, for example, in order of issue severity.

As an example, a framework can be an edge framework that provides for onsite execution for pump and pump related activities. For example, consider a PCP edge framework that can monitor the status of a PCP and perform real-time analytics to optimize the production and mitigate damaging conditions. As mentioned above, PCPs tend to be operated within a fixed operating threshold which once set, is not changed until the pump gets replaced. A PCP edge framework (PCP EF) can utilize a dynamic threshold that is determined using data driven techniques that may be coupled with the physics of operation. In such an example, a PCP EF can operate a PCP or a fleet of PCPs in an intelligent manner by taking into account surface and sub-surface factors. Such an approach can improve handling of dynamic events such as increased solids production, higher gas ingestion, low liquid production and others. While a PCP EF is mentioned, an ESP EF may be provided that can improve ESP system operations (see, e.g., FIG. 3).

As an example, a PCP EF can provide for 24 hour surveillance of PCP parameters along with production parameters, provide for real time computation of correlation coefficient between two or more parameters of interest and graphical rendering (e.g., as a bubble plot, etc.) to readily identify candidates not behaving as expected in real time; provide for remote control of wells and autonomous actions; reduce distances driven to well sites and monitoring efforts; advance intelligence review with defined input; and improve task management in a manner that leads to proactive well management.

As explained, a pump such as a PCP has been operated by operating the pump within thresholds which once set are usually left static (unchanged) until a subsequent workover. However, such thresholds do not take into account impact of a gradual change in surface and sub-surface conditions which amongst others could result from higher solids production leading to lower intake of liquid, differential pressure caused by compressor breakdown downstream of the pump, higher gas ingestion, sudden breach of the operating envelope. A pump could therefore fail if these conditions are not addressed in a timely manner.

As an example, an EF (e.g., a pump EF) can provide for early detection of changes, particularly one or more changes that can have a catastrophic impact on a pump. Such an approach can improve operations compared to a static approach as to thresholds, which tend to be not capable of preventing various types of catastrophic breakdowns.

As an example, a data driven dynamic approach can include performing a workflow that utilizes statistical analysis of historical data to identify operating ranges where an edge framework can include one or more models (e.g., machine learning models, physics-based models, etc.) based on such operating ranges where the edge framework can be deployed on an edge framework gateway, for example, to monitor, control and optimize a pump autonomously and optionally via remote communication.

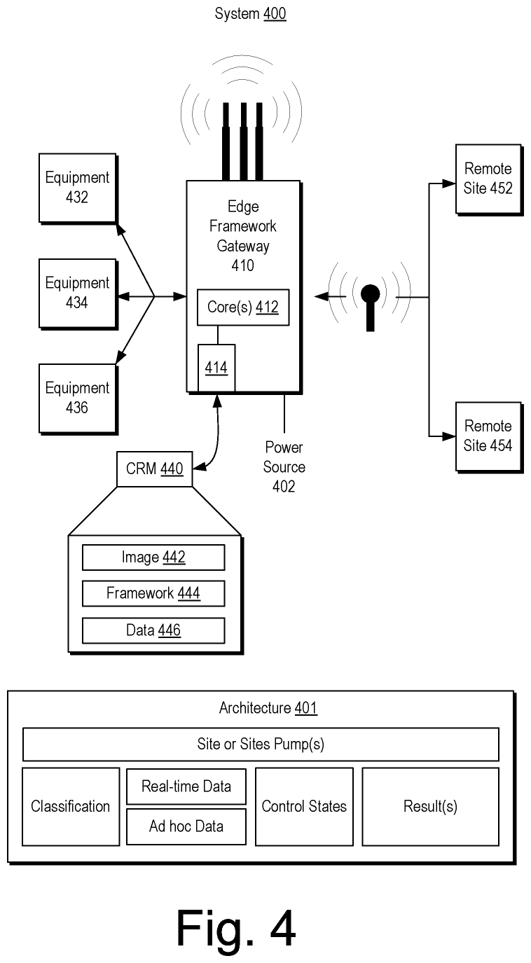

FIG. 4 shows an example of a system 400 and an example of an architecture 401. As shown, the architecture 401 can provide for one or more workflows as to a site or sites with respect to one or more pumps. As an example, the architecture 401 can generate one or more results (e.g., behavior characterizations, classifications, control actions, etc.) that can be utilized for operation at one or more sites. In such an example, the result or results may be generated locally and/or remotely (e.g., depending on number of sites, resources, etc.). As shown, the architecture 401 can include one or more classification components, one or more control states components (e.g., for control decision making), etc. The architecture 401 may include one or more physics models, one or more machine learning models, etc. As shown, the architecture 401 includes an interface for real time data, optionally an interface for ad hoc data, etc. The result(s) component may include a result interface where an output result can be a notification, an alarm, a control trigger, a control instruction, etc., that can call for an action or actions by a piece or pieces of equipment.

As shown, the system 400 can include a power source 402 (e.g., solar, generator, grid, etc.) that can provide power to an edge framework gateway 410 that can include one or more computing cores 412 and one or more media interfaces 414 that can, for example, receive a computer-readable medium 440 that may include one or more data structures such as an image 442, a framework 444 and data 446. In such an example, the image 442 may be an operating system image that can cause one or more of the one or more cores 412 to establish an operating system environment that is suitable for execution of one or more applications. For example, the framework 444 may be an application suitable for execution in an established operating system in the edge framework gateway 410. As an example, the framework 444 may be suitable for performing tasks associated with the architecture 401.

In the example of FIG. 4, the edge framework gateway 810 (EF gateway) can include one or more types of interfaces suitable for receipt and/or transmission of information. For example, consider one or more wireless interfaces that may provide for local communications at a site such as to one or more pieces of local equipment 432, 434 and 436 and/or remote communications to one or more remote sites 452 and 454. As an example, the local equipment 432, 434 and 436 can include one or more pumps, one or more sensors, etc.

As an example, the EF gateway 410 may be installed at a site that is some distance from a city, a town, etc. In such an example, the EF gateway 410 may be accessible via a satellite communication network.

A communications satellite is an artificial satellite that relays and amplifies radio telecommunication signals via a transponder. A satellite communication network can include one or more communication satellites that may, for example, provide for one or more communication channels. As of 2021, there are about 2,000 communications satellites in Earth orbit, some of which are geostationary above the equator such that a satellite dish antenna of a ground station can be aimed permanently at a satellite rather than tracking the satellite.

High frequency radio waves used for telecommunications links travel by line-of-sight, which may be obstructed by the curve of the Earth. Communications satellites can relay signal around the curve of the Earth allowing communication between widely separated geographical points. Communications satellites can use one or more frequencies (e.g., radio, microwave, etc.), where bands may be regulated and allocated.

Satellite communication tends to be slower and more costly than other types of electronic communication due to factors such as distance, equipment, deployment and maintenance. For wellsites that do not have other forms of communication, satellite communication can be limiting in one or more aspects. For example, where a controller is to operate in real-time or near real-time, a cloud-based approach to control may introduce too much latency. As shown in the example of FIG. 4, the EF gateway 410 may be deployed where it can operate locally with one or more pieces of equipment 432, 434, 436, etc., which may be for purposes of control.

As desired, from time to time, communication may occur between the EF gateway 410 and one or more remote sites 452, 454, etc., which may be via satellite communication where latency and costs are tolerable. As an example, the CRM 440 may be a removable drive that can be brought to a site via one or more modes of transport. For example, consider an air drop, a human via helicopter, plane or boat, etc.

As to an air drop, consider dropping an electronic device that can be activated locally once on the ground or while being suspended by a parachute en route to ground. Such an electronic device may communicate via a local communication system such as, for example, a local WiFi, BLUETOOTH, cellular, etc., communication system. In such an example, one or more data structures may be transferred from the electronic device (e.g., as including a CRM) to the EF gateway 410. Such an approach can provide for local control where one or more humans may or may not be present at the site. As an example, an autonomous and/or human controllable vehicle at a site may help to locate an electronic device and help to download its payload to an EF such as the EF gateway 410. For example, consider a local drone or land vehicle that can locate an air dropped electronic device and retrieve it and transfer one or more data structures from the electronic device to an EF, directly and/or indirectly. In such an example, the drone or land vehicle may establish communication with and/or read data from the electronic device such that data can be communicated (e.g., transferred to one or more EFs).

As to drones, consider a drone that includes one or more features of one or more of the following types of drones DJI Matrice 210 RTK, DJI Matrice 600 PRO, Elistair Orion Tethered Drone, Freefly ALTA 8, GT Aeronautics GT380, Skydio 2, Sensefly eBee X, Skyfront Perimeter 8, Vantage Robotics Snap, Viper Vantage and Yuneec H920 Plus Tornado. The DJI Matrice 210 RTK can have a takeoff weight of 6.2g (include battery and max 1.2 kg payload), a maximum airspeed of 13-30 m/s (30-70 mph), a range of 500m-1 km with standard radio/video though it may be integrated with other systems for further range from base, a flight time of 15-30 minutes (e.g., depending on battery and payload choices, etc.). As an example, a gateway may be a mobile gateway that includes one or more features of a drone and/or that can be a payload of a drone.

As an example, a system may include and/or provide access to various resources that may be part of an environment such as, for example, the DELFI environment (see, e.g., FIG. 1).

As an example, an EF may include a license server, a semi-empirical model(s) component, a framework simulation engine (e.g., a PIPESIM engine, etc.) and a REST API where the REST API can receive one or more API calls, for example, as one or more model requests, calibration requests, simulation requests, etc. As an example, an EF may respond to an API call with output where such output may be provided to one or more edge applications, pieces of equipment, etc. (e.g., for individual and/or coordinated control of one or more sets of equipment, etc.).

Referring again to the architecture 401, as explained, one or more physics based models can be deployed to an edge for implementation, for example, to operate responsive to real-time data, responsive to historical data, etc.

As shown in FIG. 4, an EF may execute within a gateway such as, for example, an AGORA gateway (e.g., consider one or more processors, memory, etc., which may be deployed as a “box” that can be locally powered and that can communicate locally with other equipment via one or more interfaces). As an example, a gateway can include one or more features of an AGORA gateway (e.g., v.202, v.402, etc.) and/or another gateway. For example, consider an INTEL ATOM E3930 or E3950 Dual Core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS). As an example, a gateway may include a cellular interface (e.g., 4G LTE with Global Modem/GPS, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in.

As an example, a gateway may be part of a drone. For example, consider a mobile gateway that can take off and land where it may land to operatively couple with equipment to thereby provide for control of such equipment. In such an example, the equipment may include a landing pad. For example, a drone may be directed to a landing pad where it can interact with equipment to control the equipment. As an example, a wellhead can include a landing pad where the wellhead can include one or more sensors (e.g., temperature and pressure) and where a mobile gateway can include features for generating fluid flow values using information from the one or more sensors. In such an example, the mobile gateway may issue one or more control instructions (e.g., to a choke valve, a pump, etc.).

As an example, a gateway may include hardware (e.g. circuitry) that can provide for operation of a drone. As an example, a gateway may be a drone controller and a controller for other equipment where the drone controller can position the gateway (e.g., via drone flight features, etc.) such that the gateway can control the other equipment.

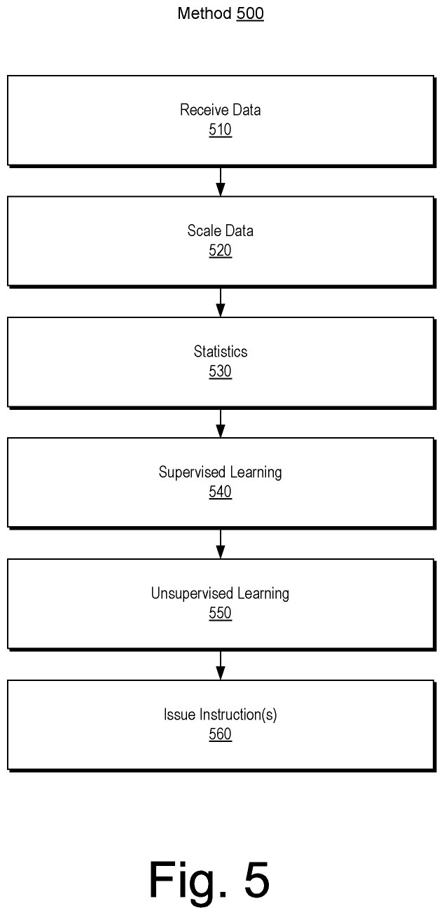

FIG. 5 shows an example of a method 500 that may be executed using an EF such as, for example, the framework 444 as executable on the EF gateway 410. As shown, the method 500 can include a reception block 510 for receiving data, a scale block 520 for scaling data, a statistics block 530 for statistically processing data (e.g., scaled data, etc.), a supervised learning block 540 for performing supervised learning of a machine learning model, an unsupervised learning block 550 for performing unsupervised learning of a machine learning model, and an issuance block 560 for issuing one or more instructions that can call for one or more types of actions.

In the example of FIG. 5, the scale block 520 may perform scaling on data with respect to other data and/or one or more factors. For example, consider data scaling that aims to address seasonal factors such that seasonal variations can be handled in pump and pump related data. As to the statistics block 530, consider performing cross plotting, gradient analysis and/or correlations. As to the supervised learning block 540, it can include performing regression analysis to train a machine learning model (ML model). As to the unsupervised learning block 550, consider performing clustering analysis by implementing one or more clustering techniques. As to the issuance block 560, consider an approach that can issue one or more types of instructions as to one or more thresholds, one or more sampling rates, one or more data requirements, etc.

As an example, the method 500 can provide for streaming analytics at an EF where real-time computation of a number of statistical parameters such as torque gradient and correlation coefficients of various parameters with respect to rod speed (e.g., pump rotor speed) are performed. In such an example, pump operating condition can be monitored at least in part by cross checking computed outputs versus one or more set dynamic thresholds.

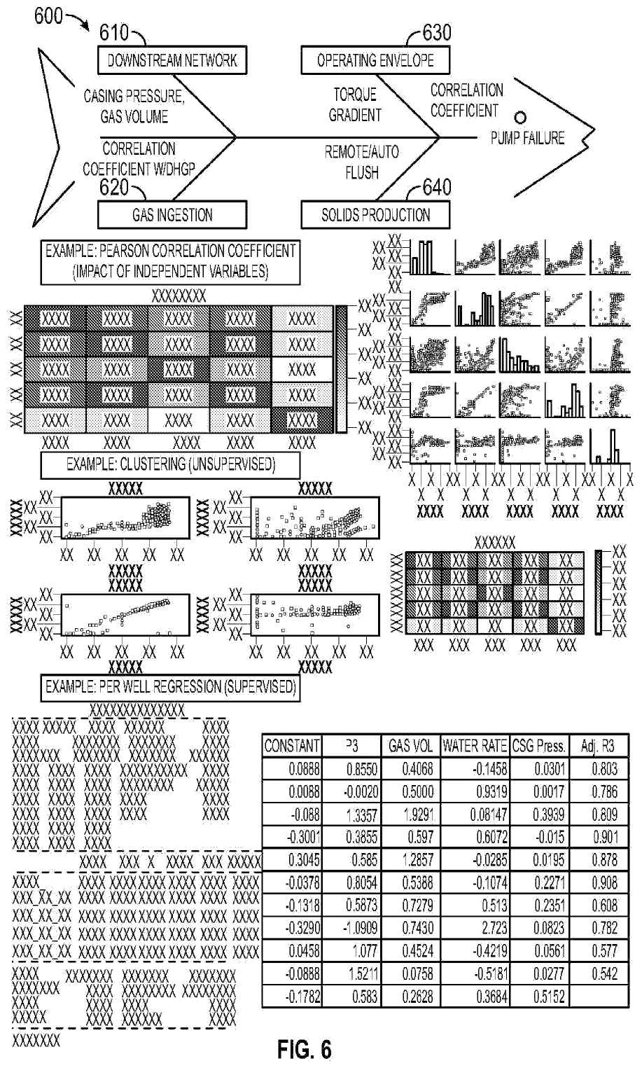

FIG. 6 shows an example of a framework 600 with components that can be included in a framework such as the framework 444 of FIG. 4. For example, consider a downstream network component 610, a gas ingestion component 620, an operating envelope component 630, and a solids production component 640. In such an example, the operating envelope component 630 can provide for utilization of torque gradient and/or correlation coefficients that can be germane to pump operation and/or pump failure (e.g., remaining useful lifetime, risk of failure, etc.). As an example, the solids production component 640 can provide for determinations as to remote operation, automated flushing, etc. As to the downstream network component 610, it can provide for data as to casing pressure and gas volume (e.g., information germane to a downstream fluid network or downstream fluid networks). As to the gas ingestion component 620, it can provide for correlation coefficients with respect to downhole gas pressure (DHGP), for example, for indications of gas ingestion; noting that gas ingestion can reduce liquid pumping (e.g., whether for PCP, ESP, etc.).

As an example, the framework 600 can include various components that can be invoked as and when a threshold is breached, which amongst other actions, may include one or more of ramping up and/or down pump speed, running a solids control remote and/or auto flush process, etc.

As mentioned, various pumps are operated using static thresholds that do not take into account dynamic conditions that a pump is subjected to. Moreover, such static operations tend to rely on uptime of a robust communication network and a high powered computing set-up on a server side. Under such conditions, an automated mode of operation is seldom used as human intervention is required to address an issue.

As explained, a method can be implemented using an edge-based application, which can utilize a data driven methodology coupled with a control mechanism deployed at the edge. Such an approach provides an ability to monitor a pump in near real time conditions and can mitigate one or more types of issues arising out of latency related to communication networks or power outages.

As explained, an edge-based approach can provide user flexibility to address an issue remotely or autonomously. The dynamic nature of an edge implemented application helps to ensure that a pump is run more optimally, which can increase its run life. Additionally, the number of trips made to wellsite can be reduced as an edge implemented application can effectuate control of a pump through local action and/or remote action.

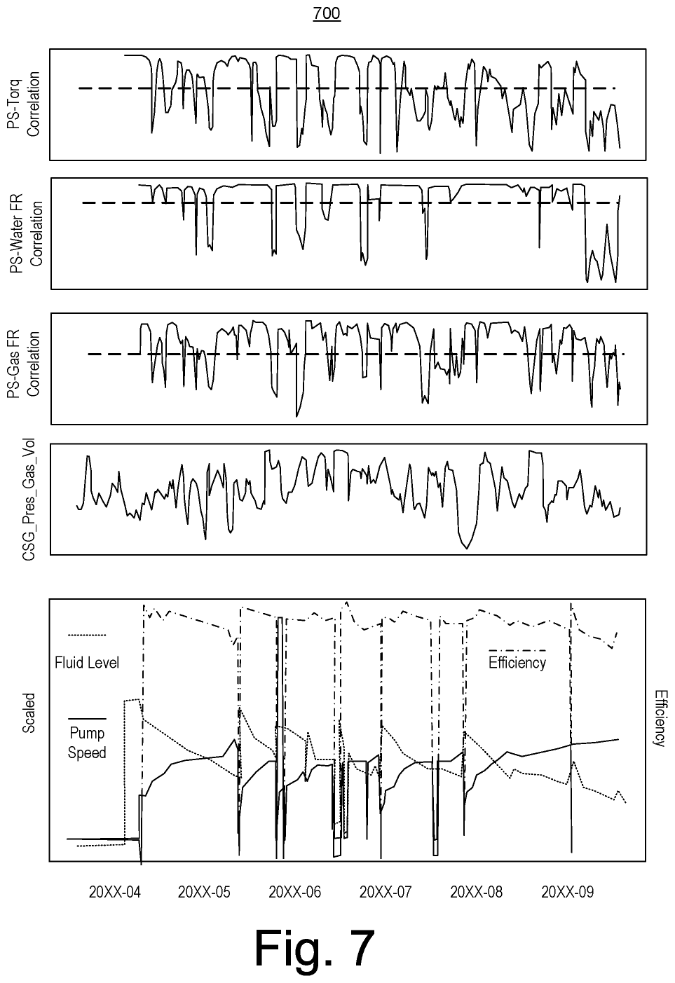

FIG. 7 shows an example series of data plots 700 that span a period of months for operation of a PCP. Specifically, the data plots 700 include a pump speed (PS) and torque correlation plot, a PS and water flow rate (FR) correlation plot, a PS and gas flow rate (FR) correlation plot, a casing pressure and gas volume correlation plot and a plot of scaled data and computed efficiency (e.g., pump efficiency). In the data plots 700, pump speed is selected for correlations as pump speed can be a controllable variable for operation of a pump. As explained, a pump can include an electric motor that is controllable as to its speed where a rotor of electric motor can be directly or indirectly coupled to a rotor of a pump. For example, an electric motor can include a rotor/stator and a pump may include a rotor/stator (see, e.g., FIG. 1) or may include a rotor with impeller blades configured with diffusers (see, e.g., FIG. 2); noting that other types of pumps may utilize other pump configurations (e.g., linear rod pump that may reciprocate according to a controlled speed, etc.).

Various data in the data plots 700 were processed using a regression technique to generate regression information and a cross correlation technique to generate correlation coefficients, as set forth below in Table 1.

TABLE 1
Correlation Coefficients

| Regression | Pump Speed | Gas Vol. | Water FR | Casing Press |
|---|---|---|---|---|
| Torque | 0.583 | 0.7626 | 0.3084 | 0.1152 |
| Rolling Corr. | PS-Torque | PS-Gas FR | PS-Water FR | PS-Casing |
| (T = 4 days) | 0.553 | 0.567 | 0.699 | 0.268 |

As indicated, a rolling correlation can be computed where, for example, a suitable window of time may be selected (e.g., in hours, days or weeks). In Table 1, the highest correlation for the window of time is for pump speed and water flow rate. As an example, one or more of regression results and rolling correlation results may be utilized as indicators of pump operation (e.g., pump behavior, etc.). For example, consider utilization of one or more thresholds with respect to regression results and/or correlation results that may provide for indications of pump operation, which may be triggers for issuance of control and/or other instructions.

As indicated in Table 1, regressions may be computed for various measurements. Such regressions may provide indicators as to how much a change in one variable will change one or more other variables. For example, consider torque and pump speed where a change in pump speed may result in a particular change in torque, which may be related to changes in gas volume, water flow rate, casing pressure, etc. As an example, regression results may be utilized in an online basis for purposes of comparisons, control, alerts, etc.

As mentioned with respect to FIG. 6, a framework can provide for computing correlation coefficients, which may be germane to control as to gas ingestion, operating envelope, etc. Such an approach can help to uncover conditions that may reduce pump life (e.g., risks of pump failure).

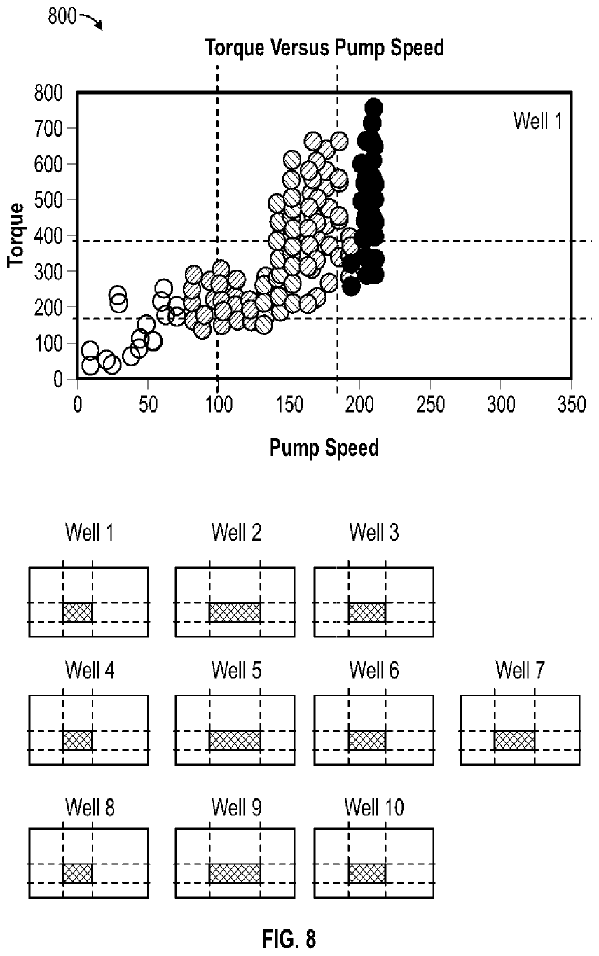

FIG. 8 shows various example plots 800 for ten wells of torque versus pump speed for a range of torque from 0 to 800 and a range of pump speeds from 0 to 350. As shown, each of the ten wells can be compared to one or more other wells whereby areas of torque and pump speed can be identified and related. For example, wells 1, 4 and 8, wells 2, 5 and 9, and wells 3, 6 and 10 form three groups as to pump speed range for a set range of torque. In the example of FIG. 8, the well 7 will not fit within the three groups and therefore may be considered to exhibit different behavior.

In the plot for well 1, clusters are indicated by shading, file and/or hatching. In such an approach, a clustering technique can be implemented to determine a suitable number of clusters, for example, consider a k-means approach (e.g., k-means nearest neighbors, etc.). In the example plot for well 1, five clusters are indicated with trends as to pump speed and torque. As an example, the clusters can be assessed as to pump operation where one or more clusters may be utilized to define suitable operational conditions such as, for example, an operational envelope (e.g., consider pump speed and torque). In such an example, an operational envelope may be on a per well basis or a multi-well basis. As an example, clustering may be performed using supervised and/or unsupervised learning. As to unsupervised learning, incoming data may be analyzed automatically, for example, via clustering, to determine dynamic operational regimes (e.g., envelope, etc.). In such an approach, dynamic control may be implemented in an effort to maintain pump operation within an envelope.

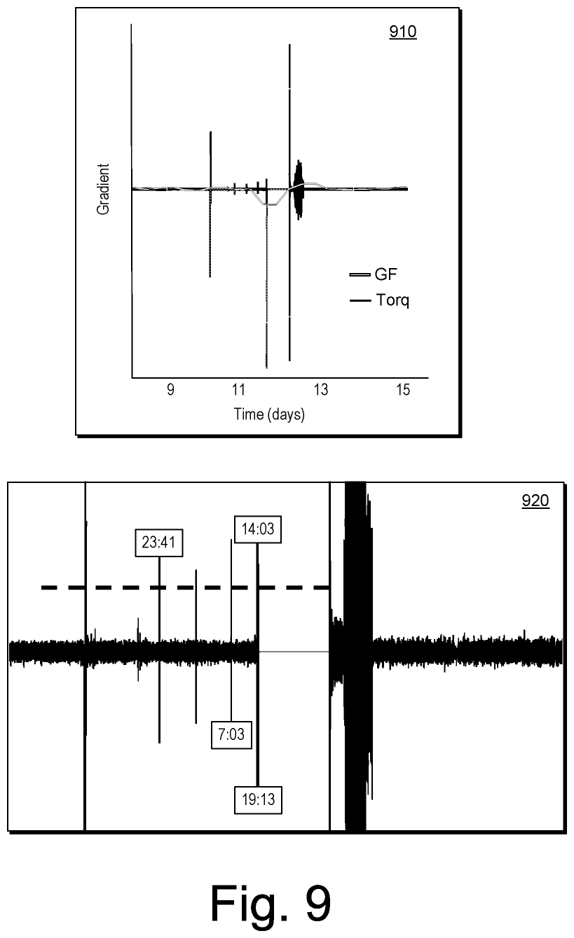

FIG. 9 shows an example plot 910 of torque gradient (solid fill line) and gradient of gas flow (white filled line) with respect to time and an enlarged portion 920 of the plot 910 as to torque gradient with respect to time. In the example of FIG. 9, various times can be discerned as to torque gradients, which can be related to gas flows. For example, gas flow decreases and then increases where it levels off after a number of changes in torque gradient values. As indicated in the plot 920, various times can be identified for spikes in torque, which may occur over approximately 20 hours (e.g., from 23:41 on day 11 to 19:13 on day 12).

In the example of FIG. 9, the plot 920 shows a period of time without gradient data, which corresponds to no operation (e.g., failure, workover time, etc.). As shown, a pump may have been tested where torque spikes became frequent, yet, somewhat limited. Thereafter, pump operation with the same pump (e.g., or a different pump) returns to suitable operation as indicated by the torque gradient.

As explained, torque gradient can be utilized as a metric to characterize pump operation. As shown in FIG. 9, such data may be supplemented with respect to one or more other types of data such as gas flow data, etc. In the example plot 920, the horizontal dashed line can represent a limit (e.g., a threshold) for torque gradient, which may be based on automatically acquired torque data and processed locally by an edge framework gateway.

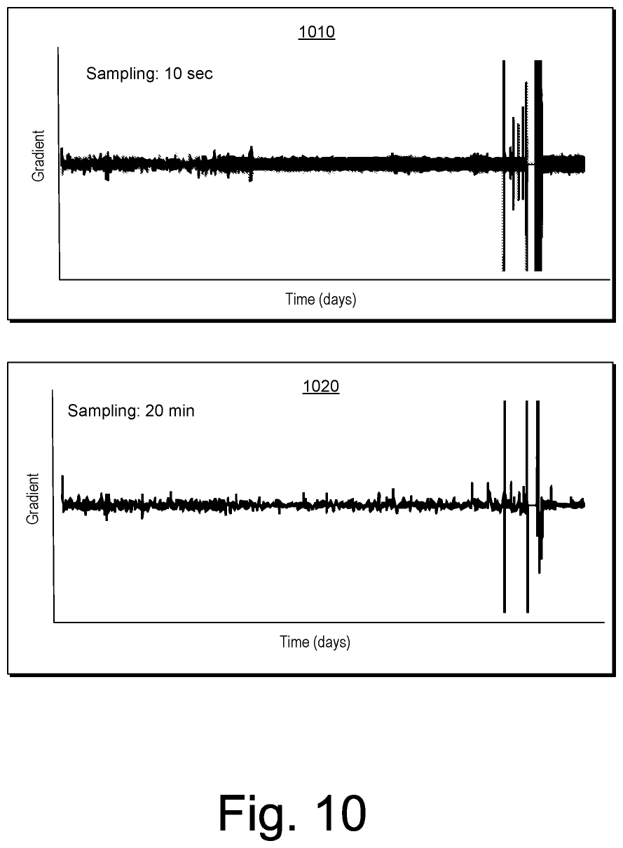

FIG. 10 shows example data plots 1010 and 1020 that pertain to data acquisition, specifically, the frequency of data acquisition or sampling rate. As shown, the plot 1010 shows data for sampling at 10 second intervals while the plot 1020 shows data for sampling at 20 minute intervals. As can be discerned, the higher frequency sampling provides for improved indications of torque behaviors. As explained with respect to the framework 600 of FIG. 6, torque and torque gradient can be related to an operating envelope where, for example, correlation coefficients of one or more operating parameter(s) may be computed with respect to torque and/or torque gradient. Correlation coefficients (see, e.g., Table 1) can provide information as to trends, behaviors, etc., which can facilitate operational decision making (e.g., to extend pump lifetime, etc.).

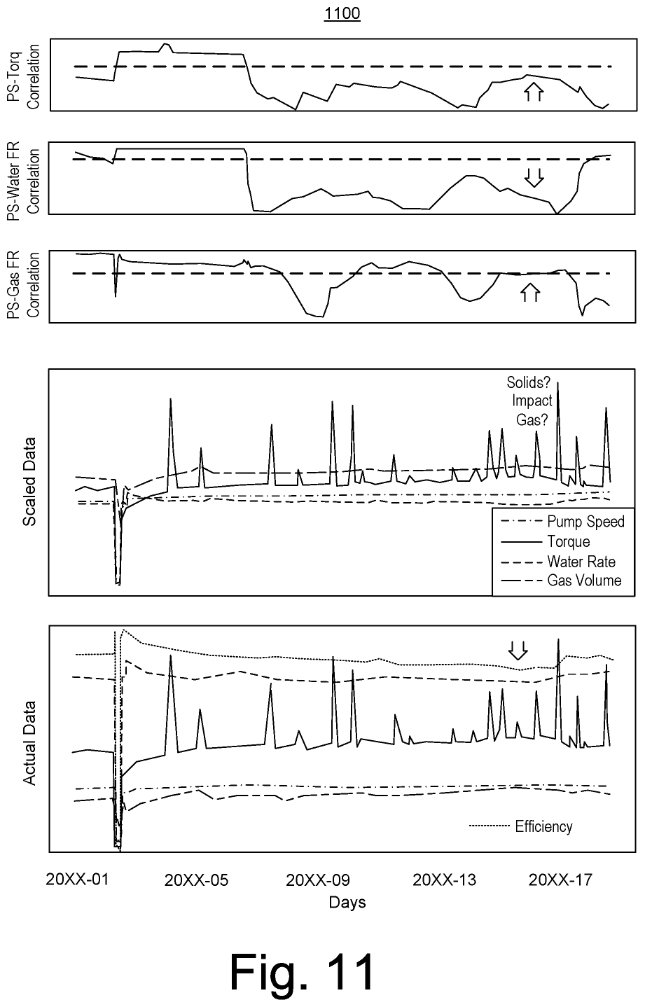

FIG. 11 shows an example series of data plots 1100 that span a period of days for operation of a PCP. Specifically, the data plots 1100 include a PS and torque correlation plot, a PS and water flow rate (FR) correlation plot, a PS and gas flow rate (FR) correlation plot, a scaled data plot and a plot of actual data that includes computed efficiency (e.g., pump efficiency).

In the example of FIG. 11, certain data over a period of time indicate an increase in PS-torque correlation, a decrease in PS-water flow rate correlation and an increase in PS-gas production correlation where efficiency is decreased. Such data can be an indicator of one or more conditions that may lead to a decrease in pump life. For example, such data can be indicators of the presence of an elevated level of solids, an impact of gas in a pump cavity, etc. As explained with respect to the framework 600 of FIG. 6, the gas ingestion component 620 may call for one or more actions to address gas ingestion (e.g., gas content above a threshold, which may be dynamic) and the solids production component 640 may call for one or more actions to address presence of solids (e.g., a solids content above a threshold, which may be dynamic).

In the example of FIG. 11, the data of the plots 1100 can be transmitted locally to an edge framework gateway that can execute an edge framework (see, e.g., the framework 444 of FIG. 4, which may provide for execution of one or more edge applications). In the example of FIG. 11, one or more correlation techniques may be utilized, for example, to compute correlation coefficients, which may be within one or more windows (e.g., hours, days, weeks, etc.). As explained, such an approach can provide for uncovering trends and/or behaviors that may be addressed through one or more control actions. Such an approach can help to provide an operating envelope of a pump that extends the life of the pump. As explained, such an approach, as implemented on the edge, may be autonomous such that demand for human intervention is reduced.

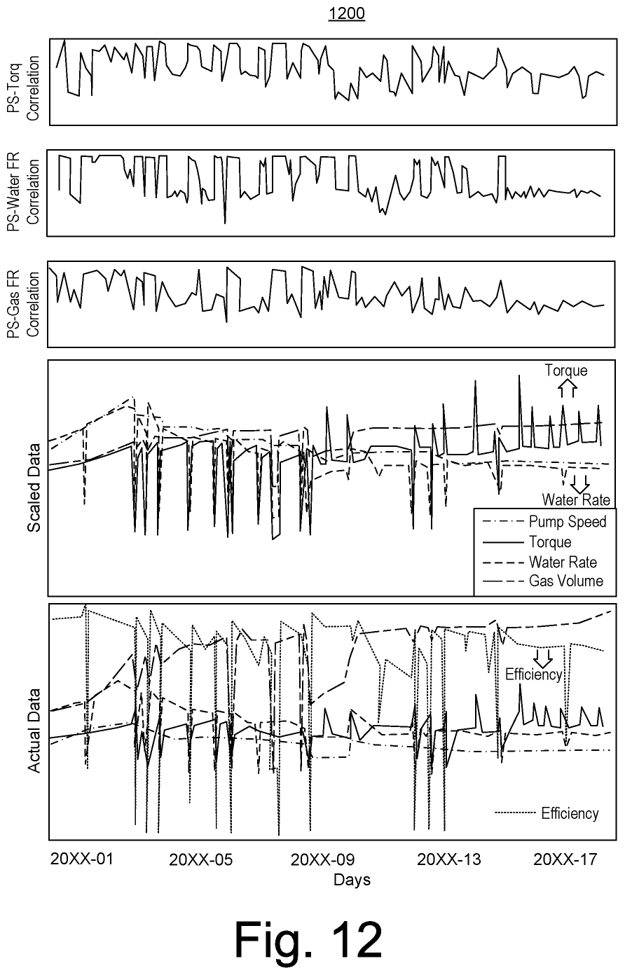

FIG. 12 shows an example series of data plots 1200 that span a period of days for operation of a PCP. Specifically, the data plots 1200 include a PS-torque correlation plot, a PS-water flow rate (FR) correlation plot, a PS-gas flow rate (FR) correlation plot, a scaled data plot and a plot of actual data that includes computed efficiency.

In the example of FIG. 12, a period of time is identified where torque is increasing, water flow rate decreasing and gas volume remaining relatively unchanged (e.g., relatively constant). In that period of time, the efficiency is decreasing. Such data can be indicative of one or more conditions that may impact pump longevity. As explained, data such as in the plots 1100 of FIG. 11 and the plots 1200 of FIG. 12 may be acquired by an edge framework gateway that can execute on edge framework that can uncover trends and/or behaviors and call for one or more control actions that aim to extend pump longevity and/or reduce demand for onsite human intervention.

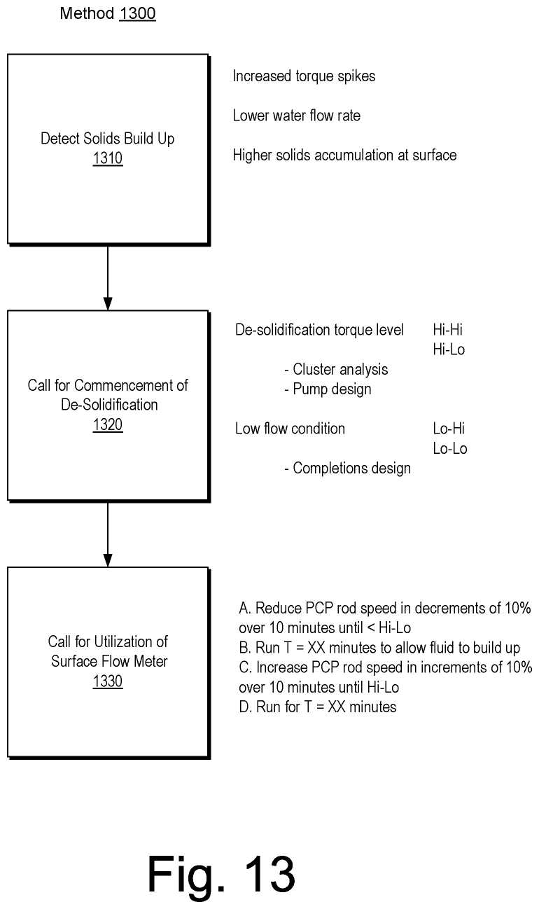

FIG. 13 shows an example of a method 1300 that includes a detection block 1310 for detecting solids build up (e.g., solids content above a threshold, etc.), a call block 1320 for calling for commencement of a de-solidification process, and a call block 1330 for calling for utilization of a surface flow meter.

As shown in the example of FIG. 13, the detection block 1310 can provide for assessing data for trends and/or behaviors such as, for example, an increase in torque spikes, a lower water flow rate and/or a higher solids accumulation at surface.

As explained with respect to the system 200 of FIG. 2, a site can include the separations equipment 270, which may include a solids chamber 280. In such an example, the solids chamber 280 may be of a fixed volume that demands human intervention to empty the solids chamber 280 once it is full (e.g., reaches a particular volumetric solids capacity). As an example, a solids chamber 280 may include one or more sensors that can provide information as to solids accumulation, which may be utilized, for example, by an edge framework for making a decision or decisions with respect to pump operations.

In the example of FIG. 13, the call block 1320 can, for example, call for a particular process that aims to reduce solids that may be present in a pump (e.g., a pump cavity, pump cavities, etc.). As shown, torque may be controlled in a de-solidification process where one or more of a cluster analysis and pump design may be considered. As to a low flow condition, it may consider completions design. As an example, various conditions may be described using Hi and Lo indicators, where Hi is relatively greater than Lo and Lo is relatively lesser than Hi. As an example, conditions can be “Hi-Hi”, “Hi-Lo”, “Lo-Hi” and “Lo-Lo”. As an example, Hi and Lo can be corresponding thresholds and may define operational envelopes, etc. In such examples, thresholds may be Hi and Li for torque and Hi and Lo for correlation of torque with respect to another parameter (e.g., pump speed, etc.) and/or Hi and Lo for another parameter such as pump speed (e.g., high torque and low pump speed, etc.).

In various instances, an operator dealing with a perceived solids issue may increase pump speed thinking that will resolve the solids issue. However, slowing down the pump in increments (e.g., 5% to 10% over 30 minutes, etc.) until reaching a low speed, which can result in water build up. Once the water is built up, it can provide for a reduction in friction to lubricate a pump such that solids can then be pumped at a higher pump speed to pump out the solids in a manner that has a reduced risk of damaging the pump (e.g., elastomeric and/or other component(s)).

In the example of FIG. 13, the call block 1330 can, for example, call for utilization of a process that can include acquiring information from a surface flow meter. As shown, a process can include: reducing a PCP rod speed in decrements of a particular percentage (e.g., 10 percent, etc.) over a particular interval of time (e.g., 10 minutes, etc.) until a particular transition in behavior is indicated (e.g., less than a Hi-Lo condition); running the PCP for a particular period of time to allow fluid to build up; increasing PCP rod speed in increments of a particular percentage (e.g., 10 percent, etc.) over a particular interval of time (e.g., 10 minutes) until a particular transition in behavior is indicated (e.g., less than a Hi-Lo condition); and running the PCP for a particular period of time.

As an example, an edge framework may call for control of a pump in a manner whereby a solids flushing process is performed automatically, optionally according to a schedule. In such an example, the edge framework may include calling for an unscheduled flushing process where one or more conditions are detected. As an example, a schedule may be automatically adjusted based on conditions.

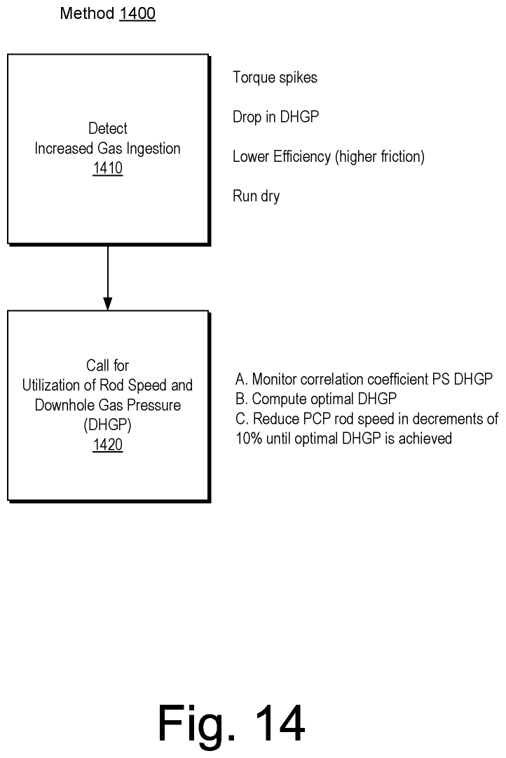

FIG. 14 shows an example of a method 1400 that include a detection block 1410 for detecting increased gas ingestion and a call block 1420 for calling for utilization of rod speed and downhole gas pressure (DHGP) to address the detected increase in gas ingestion.

As shown in FIG. 14, the detection block 1410 can include identification of torque spikes, a drop in DHGP, lower efficiency (e.g., increased friction) and/or dry running. As shown in FIG. 14, the call block 1420 can include calling for implementation of a process that includes monitoring correlation coefficient for PS DHGP, computing an optimal DHGP, and reducing PCP rod speed in decrements (e.g., 10 percent, etc.) until the optimal DHGP is achieved.

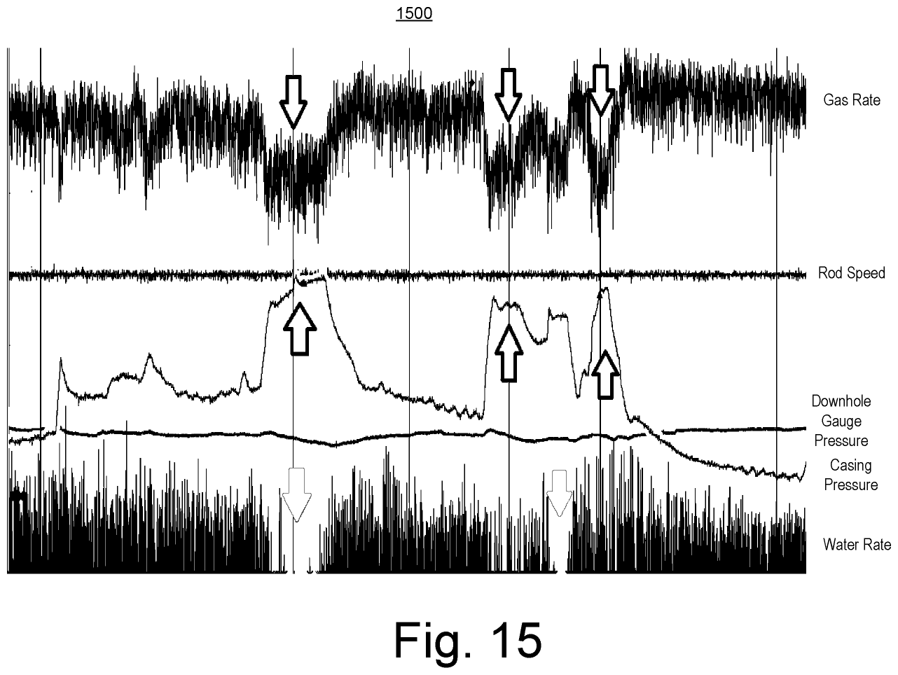

FIG. 15 shows an example plot 1500 that includes data as to gas rate, rod speed, downhole gauge pressure (DHGP), casing pressure and water rate. As shown in the plot 1500, an edge framework can achieve stable DHGP and rod speed where a change in casing gas pressure is approximately 10 psi with lower gas volume and lower water flow rate. In the example of FIG. 15, indications of changes in casing pressure can be utilized, for example, as to risk of pump failure. For example, a sudden change in casing pressure can increase risk of pump failure.

As an example, data in the plot 1500 may be assessed using the downstream network component 610 of the framework 600 of FIG. 6. For example, casing pressure and gas volume can be downstream factors germane to pump operations.

As explained, a framework may be implemented using edge computing resources to acquire data at a desired frequency (e.g., sampling rate, etc.). Such an approach can provide for streaming analytics onsite at the edge and output of various instructions that can help to increase pump lifetime and/or reduce demand for local onsite human intervention. As mentioned, an edge-based approach can automatically call for implementation of a flushing process for de-solidification of a pump, which may, for example, help to maintain available space in a solids chamber.

As an example, a framework may be updatable, for example, via one or more network connections, local drops, etc. As an example, a framework may be updatable in real time.

As an example, a framework can provide for a reduction in bandwidth by processing information locally onsite prior to transmission via a network (e.g., satellite, etc.). In such an example, the framework may decide when and/or what type of information to transmit. As explained, such an approach may utilize a relatively high data acquisition frequency and analyze such data as to trends and/or behaviors. In such an approach, trends and/or behaviors may be coded where a code can be transmitted to a remote location (e.g., offsite). In such an example, if additional information is desired, a remote call to an edge framework may request such additional information, which may be assessed for purposes of decision making, which can include issuance of one or more control instructions from a remote site to the local site. Such an approach can be tiered in an effort to reduce demand of having to send a human to the local site to intervene.

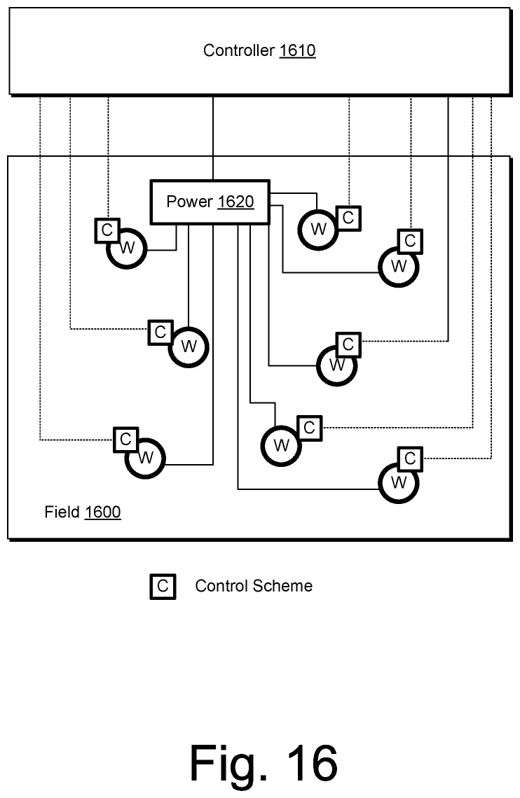

FIG. 16 shows an example of a field 1600 that includes a controller 1610 and a power supply 1620 that can supply power to pumps at a number of wells where control schemes can be implemented for each of the wells. In such an example, the control schemes can be provided by an edge framework that can execute on an edge framework gateway. Such an approach can account for power supplied by the power supply 1620, which may be an onsite gas turbine generator that generates electrical power from combustion of a portion of gas produced by one or more of the wells. In such an example, a failure of the power supply 1620 can lead to shut down of pumps at the wells. Hence, the power supply 1620 may be operated in a manner to extend its lifetime and/or reduce demand for human intervention. For example, operating ranges of the power supply 1620 may be controlled such that a total power level is not above a level that would substantially reduce lifetime of the power supply 1620. In such an example, a total power demand of the pumps of the wells may be limited and distributed accordingly to achieve desired optimal operation of the pumps as a fleet.

As mentioned, one or more machine learning techniques may be utilized to enhance process operations, a process operations environment, a communications framework, etc. As explained, various types of information can be generated via operations of a communications framework where such information may be utilized for training one or more types of machine learning models to generate one or more trained machine learning models, which may be deployed within one or more frameworks, environments, etc.

As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange with various other frameworks.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support, covering ANDROID and iOS devices, embedded LINUX, and microcontrollers. Diverse language support, which includes JAVA, SWIFT, Objective-C, C++, and PYTHON. High performance, with hardware acceleration and model optimization. Machine learning tasks may include, for example, image classification, object detection, pose estimation, question answering, text classification, etc., on multiple platforms.

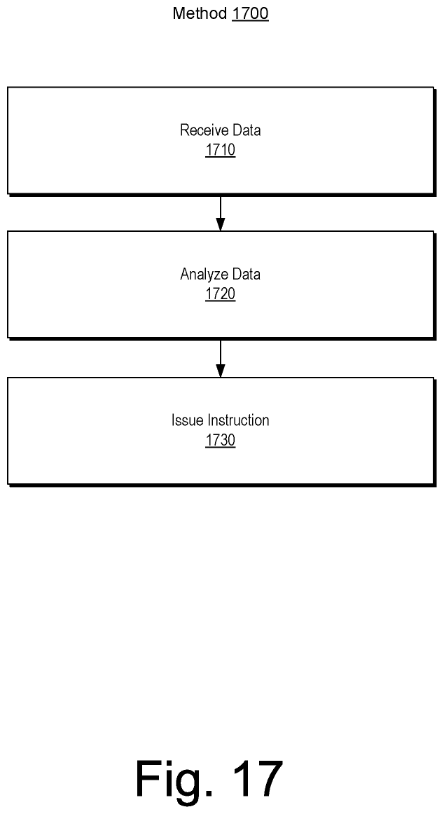

FIG. 17 shows an example of a method 1700 that includes a reception block 1710 for receiving data for a downhole pump operation that utilizes equipment that includes a pump; an analysis block 1720 for analyzing the data utilizing a local edge framework that executes a trained machine learning model to identify an operational condition of the downhole pump operation associated with a risk of a reduction in operational lifetime of the pump; and an issuance block 1730 for issuing an instruction to the equipment that addresses the operational condition.

In such an example, the operational condition can pertain to solids where, for example, the instruction includes a solids flushing process instruction. In such an example, the instruction can be to control speed of an electric motor operatively coupled to the pump.

As an example, an operational condition can pertain to gas where, for example, an instruction includes a gas liberation process instruction. In such an example, the instruction can be to control speed of an electric motor operatively coupled to the pump.

As an example, a method can include analyzing that characterizes torque. For example, consider analyzing that identifies torque spikes associated with solids build up and/or analyzing that identifies torque spikes associated with gas ingestion.

As an example, a trained machine learning model may be trained via unsupervised learning and/or supervised learning.

As an example, a trained machine learning model can include thresholds where, for example, the thresholds may include at least one dynamic threshold.

As an example, an instruction can be or include a pump speed control instruction.

As an example, data can include gas turbine generator data where, for example, the gas turbine generator data correspond to operation of a gas turbine generator that generates electrical power that operates at least one pump. In such an example, for a coal steam gas operation, a portion of gas produced at least in part via operation of a pump or pumps may be utilized to power the gas turbine generator. In such an example, where gas production drops, operation of the gas turbine generator may become an issue where an instruction may be issued to control operation of the gas turbine generator.

As an example, a method can include coordinating issuance of control instructions for a plurality of downhole pump operations. For example, consider coordination of pumps with respect to one or more gas turbine generators that may be operational via combustion of gas produced via at least one of the plurality of downhole pump operations.

As an example, a system can include a processor; memory accessible to the processor; processor-executable instructions stored in the memory and executable by the processor to instruct the system to: receive data for a downhole pump operation that utilizes equipment that includes a pump; analyze the data utilizing a local edge framework that executes a trained machine learning model to identify an operational condition of the downhole pump operation associated with a risk of a reduction in operational lifetime of the pump; and issue an instruction to the equipment that addresses the operational condition.

As an example, one or more computer-readable storage media can include processor-executable instructions to instruct a computing system to: receive data for a downhole pump operation that utilizes equipment that includes a pump; analyze the data utilizing a local edge framework that executes a trained machine learning model to identify an operational condition of the downhole pump operation associated with a risk of a reduction in operational lifetime of the pump; and issue an instruction to the equipment that addresses the operational condition.

As an example, a computer program product can include one or more computer-readable storage media that can include processor-executable instructions to instruct a computing system to perform one or more methods and/or one or more portions of a method.

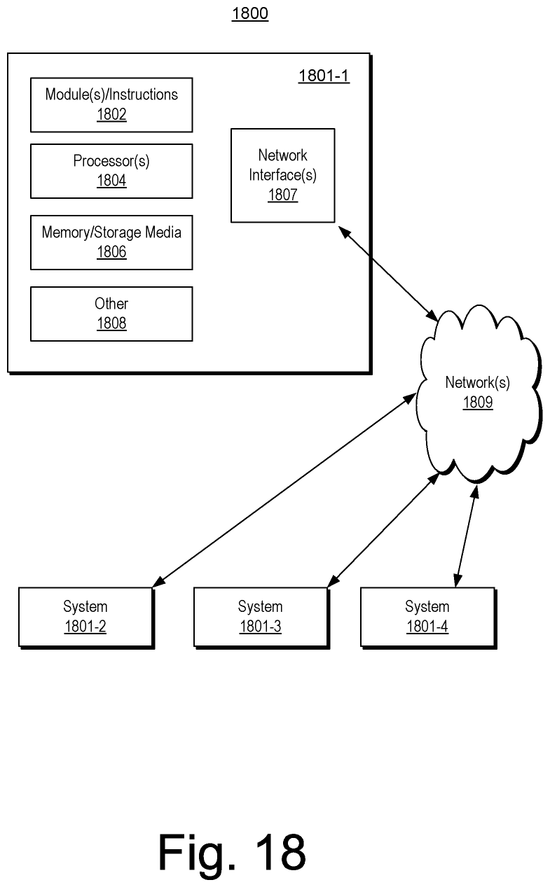

In some embodiments, a method or methods may be executed by a computing system. FIG. 18 shows an example of a system 1800 that can include one or more computing systems 1801-1, 1801-2, 1801-3 and 1801-4, which may be operatively coupled via one or more networks 1809, which may include wired and/or wireless networks.

As an example, a system can include an individual computer system or an arrangement of distributed computer systems. In the example of FIG. 18, the computer system 1801-1 can include one or more modules 1802, which may be or include processor-executable instructions, for example, executable to perform various tasks (e.g., receiving information, requesting information, processing information, simulation, outputting information, etc.).

As an example, a module may be executed independently, or in coordination with, one or more processors 1804, which is (or are) operatively coupled to one or more storage media 1806 (e.g., via wire, wirelessly, etc.). As an example, one or more of the one or more processors 1804 can be operatively coupled to at least one of one or more network interface 1807. In such an example, the computer system 1801-1 can transmit and/or receive information, for example, via the one or more networks 1809 (e.g., consider one or more of the Internet, a private network, a cellular network, a satellite network, etc.).

As an example, the computer system 1801-1 may receive from and/or transmit information to one or more other devices, which may be or include, for example, one or more of the computer systems 1801-2, etc. A device may be located in a physical location that differs from that of the computer system 1801-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1806 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include general purpose processors or application specific chips (e.g., or chipsets), such as ASICs, FPGAs, PLDs, or other appropriate devices.

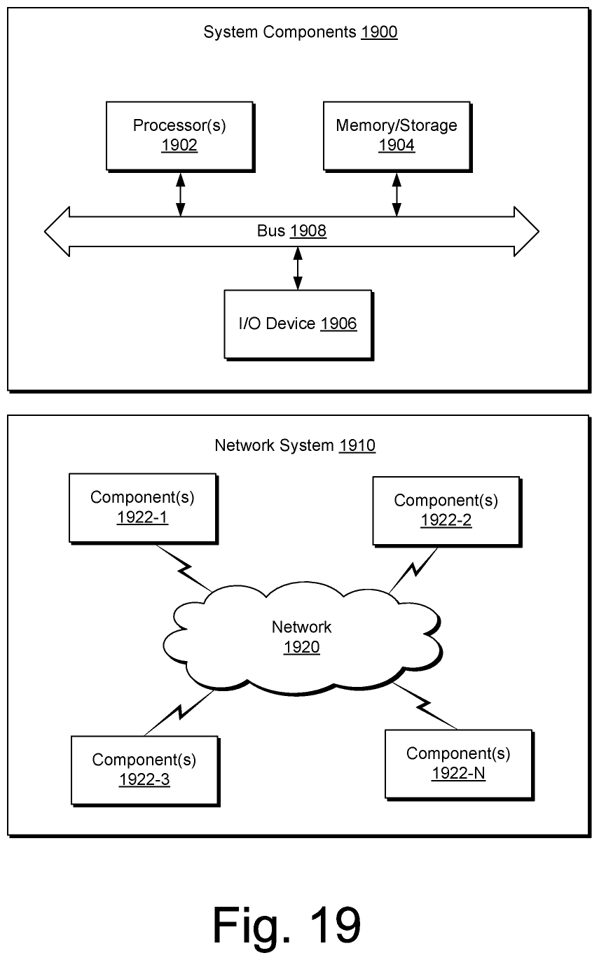

FIG. 19 shows components of an example of a computing system 1900 and an example of a networked system 1910 with a network 1920. The system 1900 includes one or more processors 1902, memory and/or storage components 1904, one or more input and/or output devices 1906 and a bus 1908. In an example embodiment, instructions may be stored in one or more computer-readable media (e.g., memory/storage components 1904). Such instructions may be read by one or more processors (e.g., the processor(s) 1902) via a communication bus (e.g., the bus 1908), which may be wired or wireless. The one or more processors may execute such instructions to implement (wholly or in part) one or more attributes (e.g., as part of a method). A user may view output from and interact with a process via an I/O device (e.g., the device 1906). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1910. The network system 1910 includes components 1922-1, 1922-2, 1922-3, . . . 1922-N. For example, the components 1922-1 may include the processor(s) 1902 while the component(s) 1922-3 may include memory accessible by the processor(s) 1902. Further, the component(s) 1922-2 may include an I/O device for display and optionally interaction with a method. The network 1920 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving data for a downhole pump operation that utilizes equipment that comprises a pump;
analyzing the data utilizing a local edge framework that executes a trained machine learning model to identify an operational condition of the downhole pump operation associated with a risk of a reduction in operational lifetime of the pump; and
issuing an instruction to the equipment that addresses the operational condition.

2. The method of claim 1, wherein the operational condition pertains to solids.

3. The method of claim 2, wherein the instruction comprises a solids flushing process instruction.

4. The method of claim 3, wherein the instruction comprises an instruction to control speed of an electric motor operatively coupled to the pump.

5. The method of claim 1, wherein the operational condition pertains to gas.

6. The method of claim 5, wherein the instruction comprises a gas liberation process instruction.

7. The method of claim 6, wherein the instruction comprises an instruction to control speed of an electric motor operatively coupled to the pump.

8. The method of claim 1, wherein the analyzing characterizes torque.

9. The method of claim 8, wherein the analyzing identifies torque spikes associated with solids build up.

10. The method of claim 8, wherein the analyzing identifies torque spikes associated with gas ingestion.

11. The method of claim 1, wherein the trained machine learning model is trained via unsupervised learning.

12. The method of claim 1, wherein the trained machine learning model is trained via supervised learning.

13. The method of claim 1, wherein the trained machine learning model comprises thresholds.

14. The method of claim 13, wherein the thresholds comprise at least one dynamic threshold.

15. The method of claim 1, wherein the instruction comprises a pump speed control instruction.

16. The method of claim 1, wherein the data comprise gas turbine generator data.

17. The method of claim 16, wherein the gas turbine generator data correspond to operation of a gas turbine generator that generates electrical power that operates at least the pump.

18. The method of claim 1, comprising coordinating issuance of control instructions for a plurality of the downhole pump operations.

19. A system comprising:
a processor;
memory accessible to the processor;
processor-executable instructions stored in the memory and executable by the processor to instruct the system to:
receive data for a downhole pump operation that utilizes equipment that comprises a pump;
analyze the data utilizing a local edge framework that executes a trained machine learning model to identify an operational condition of the downhole pump operation associated with a risk of a reduction in operational lifetime of the pump; and
issue an instruction to the equipment that addresses the operational condition.

20. One or more computer-readable storage media comprising processor-executable instructions to instruct a computing system to:
receive data for a downhole pump operation that utilizes equipment that comprises a pump;
analyze the data utilizing a local edge framework that executes a trained machine learning model to identify an operational condition of the downhole pump operation associated with a risk of a reduction in operational lifetime of the pump; and
issue an instruction to the equipment that addresses the operational condition.
